(19) United States
(12) Patent Application Publication
(10) Pub. No.: US 2024/0062104 A1
(43) Pub. Date: Feb. 22, 2024

(54) Inference Performance Using Divide-and-Conquer Techniques

(71) Applicant: Oracle International Corporation, Redwood City, CA (US)

(72) Inventor: Alex Kogan, Needham, MA (US)

(21) Appl. No.: 18/176,342

(22) Filed: Feb. 28, 2023

Related U.S. Application Data
(60) Provisional application No. 63/371,617, filed on Aug. 16, 2022.

(51) Int. Cl. G06N 20/00

(52) U.S. Cl. CPC G06N 20/00

(57) ABSTRACT

Systems, computer instructions encoded on non-transitory computer-accessible storage media and computer-implemented methods are disclosed for improving the inference performance of machine learning systems using a divide-and-conquer technique. An application configured to perform inferences using a trained machine learning model may be evaluated to identify opportunities to execute the portions of the application in parallel. The application may then be divided into multiple independently executable tasks according to the identified opportunities. Weighting values for individual ones of the tasks may be assigned according to expected computational intensity values of the respective tasks. Then, computational resources may be distributed among the tasks according to the respective weighting values and the application executed using the distributed computational resources.

This application claims benefit of priority to U.S. Provisional Application Ser. No. 63/371,617, entitled “Improved Inference Performance Using Divide-and-Conquer Techniques,” filed Aug. 16, 2022, and which is hereby incorporated herein by reference in its entirety.

### BACKGROUND

### Field of the Disclosure

This disclosure relates generally to computer hardware and software, and more particularly to systems and methods for implementing machine learning systems.

### Description of the Related Art

Improvements in Machine Learning inferences have traditionally focused on improving the accuracy and training of machine learning models. However, traditional techniques for performing inferences often result in poor performance and do not scale well when additional computational resources are added. While inference engines could be restructured to mitigate scalability issues, such rewriting of machine learning system may prove prohibitively costly.

### SUMMARY

Systems, computer instructions encoded on non-transitory computer-accessible storage media and computer-implemented methods for improving the inference performance of machine learning systems using a divide-and-conquer technique are disclosed. An application configured to perform inferences using a trained machine learning model may be evaluated to identify opportunities to execute the portions of the application in parallel. The application may then be divided into multiple independently executable tasks according to the identified opportunities. Weighting values for individual ones of the tasks may be assigned according to expected computational intensity values of the respective tasks. Then, computational resources may be distributed among the tasks according to the respective weighting values and the application executed using the distributed computational resources.

### BRIEF DESCRIPTION OF THE DRAWINGS

FIG. 1 is a block diagram illustrating preparation of a machine learning application for execution using a divide-and-conquer technique, in various embodiments.

FIG. 2 is a block diagram illustrating an optical character recognition system accelerated using a divide-and-conquer technique and dynamic resource allocation, in various embodiments.

FIG. 3 is a block diagram illustrating an optical character recognition system accelerated using a divide-and-conquer technique, in various embodiments.

FIG. 4 is a flow diagram illustrating preparation of an application for execution using a divide-and-conquer technique, in various embodiments.

FIG. 5 is a flow diagram illustrating scheduling of a divided application for execution according to assigned core counts, in various embodiments.

FIG. 6 is a block diagram illustrating one embodiment of a computing system that is configured to execute applications using a divide-and-conquer technique, as described herein.

While the disclosure is described herein by way of example for several embodiments and illustrative drawings, those skilled in the art will recognize that the disclosure is not limited to embodiments or drawings described. It should be understood that the drawings and detailed description hereto are not intended to limit the disclosure to the particular form disclosed, but on the contrary, the disclosure is to cover all modifications, equivalents and alternatives falling within the spirit and scope as defined by the appended claims. Any headings used herein are for organizational purposes only and are not meant to limit the scope of the description or the claims. As used herein, the word “may” is used in a permissive sense (i.e., meaning having the potential to) rather than the mandatory sense (i.e. meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112(f) interpretation for that unit/circuit/component.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

### DETAILED DESCRIPTION OF EMBODIMENTS

Improvements in Machine Learning inferences have traditionally focused on improving the accuracy and training of machine learning models. However, traditional techniques for performing inferences often result in poor performance and scale poorly when deployed on central processing units (CPUs). While inference engines could be restructured to mitigate scalability issues, such rewriting of machine learning system may prove prohibitively costly.

Instead, a simple yet effective approach based on a Divide-and-Conquer Principle may be employed. Given an application to execute, such as an inference job using a machine learning model, instead of using all available computing resources (i.e., CPU cores), an application deployment tool or system may evaluate the application to divide the application into independent parts that may be executed in parallel, each with the number of cores assigned according to its expected computational cost.

Machine learning (ML) systems have undergone unprecedented growth, with new ML models being proposed and developed across a variety of domains such as video, images and text. Over time, these models grow bigger and more sophisticated with their components continuously revised to achieve better accuracy scores on various tasks. While much attention is given to training efficiency and prediction accuracy, less effort is focused on making sure those models perform well when deployed in practice, e.g., during inference.

Some models scale poorly when the number of available cores in a CPU-based deployment is increased. There are a variety of reasons for these scaling problems ranging from the micro-level, such as the use of non-scalable operators inside ML architectures, to macro-level, such as employing ML architectures that process input iteratively.

To mitigate those scalability challenges, ML architectures may be redesigned or reimplemented to replace non-scalable operations with more efficient, more scalable versions. Such approaches, however, require either substantial ML domain-specific expertise, exceptional engineering skills and familiarity with ML frameworks used for inference, significant investments (e.g., to retrain a new model, with a potential risk to the accuracy metrics), or multiple ones of the above.

As an alternative, poor scalability of ML models may actually be leveraged to improve performance by applying a Divide-and-Conquer Principle. Specifically, instead of allocating all available computing resources (CPU cores) to the entire problem, the ML inference application may be divided into smaller chunks, then the application deployment system, or framework, may decide how computing resources should be allocated among those chunks to run their respective computations in parallel. In many use cases, such divisions are natural and require little or no changes in the user code. In some embodiments, computing resources may be allocated based on the expected computational intensity (or weight) of each application chunk.

Consider, for example, a model for solving a natural language processing (NLP) task such as message classification. Using a divide-and-conquer approach allows efficient batching of inference requests of various sizes, eliminating the need for padding, a common but wasteful solution to deal with batches of requests of variable size, while allowing the application to statically or dynamically allocate computing resources proportionally to the length of each sequence. Such an implementation may be implemented using popular frameworks for training and inferencing ML models by extending inference Application Programming Interfaces (APIs) to allow user code to invoke parallel inference on multiple inputs.

There are numerous reasons that machine learning inferences exhibit poor scalability. One reason is simply because the amount of computation required by a model during inference is insufficient for efficient parallelization. Kernel implementations of various ML operations are often geared towards training, where sizable batches of large inputs are typically used. During inference, however, batches tend to be much smaller and often include just one input (e.g., for real-time/interactive inference). In addition, the inputs themselves can be small, e.g., a tweet or chatbot interaction consisting of just a few words.

For example, some ML frameworks rely heavily on matrix multiplication primitives. Those primitives are known to scale well for large matrices. However, when the actual input to the model during inference is short, matrix multiplications involve smaller matrices less amendable to efficient parallelization.

Another reason for poor scalability of some ML models is the use of non-scalable (and often, sequential) operators in the architecture. Typically, the overhead of those operators would be negligible compared to other, more scalable parts of the model. Yet, as the number of cores increases, the negative impact of non-scalable operators on the overall inference performance may grow.

For example, while matrix multiplication scales well, at least for long inputs, other operations such as layer normalization and softmax do not, contributing to the overall poor scalability of some models. An example is a model for image processing, which may employ sequentially implemented functions for internal format conversions. These conversions may cause the entire model not to scale.

While some issues might be considered performance anomalies in the underlying ML framework and could be fixed by reimplementing respective operators with more efficient (and parallel) alternatives, this may require significant engineering effort including performance analysis and deep understanding of corresponding framework implementation details. In addition, some ML operators, such as layer normalization, require careful coordination among computing threads (e.g., to compute variance and standard deviation of all the hidden units in a layer and then use those statistics to normalize the values of the units) and therefore do not lend themselves naturally for efficient parallelization and restructuring of the underlying ML framework.

In a related issue, an ML framework might add small but measurable overhead in invoking model operations. Most popular ML frameworks support multiple backends for executing ML operations targeting different hardware architectures (CPU, GPU, TPU) and utilizing different software libraries, different threading infrastructures, etc. Dispatching appropriate kernels for every operator is efficient but is sequential and requires non-trivial amount of work, especially when the model is executed interactively. This overhead becomes substantial as the actual execution time of the kernels reduces with the increased number of cores.

In addition to the above, various kernels might require specific memory layout for its input parameters (tensors), and the framework may add appropriate dummy operators for input/output conversion or data preparation. These operators may add substantial overhead as well.

Quite often the high-level architecture of an ML model itself plays a substantial role in causing inference scaling failures. For instance, some ML models, especially ones built for video and image processing are composed as a multi-phase pipeline. The first phase of the pipeline would typically identify the points of interest in the input (e.g., text boxes in an image or a moving object in a video), while subsequent phases would process those points (iteratively or as a batch) to solve the predefined problem (e.g., identify text in the boxes or classify the moving object in the video). The inference latency of such models might grow linearly with the number of objects identified in the first phase. If only one phase of the pipeline does not scale well, the scalability of the entire pipeline is impaired.

Batching multiple inputs and processing them at once is a well-known way of improving inference throughput. In fact, multiple systems for machine learning models include tunable parameters that configure how long an inference server may wait in order to batch as many input requests as possible. However, when inputs in a batch do not have exactly the same shape, they need to be padded to be processed efficiently, since underlying kernels typically anticipate batches of homogenous inputs. The padding leads to reduced computational efficiency, since it is treated by kernels as the rest of the input, even though the corresponding output produced by the model is dismissed.

The application, or computation job, J, may be broken into k independent parts, j1, j2, . . . jk, which may be executed in parallel. In some embodiments, relative weights wi E (0, 1] corresponding to, e.g., the number of required floating point operations (FLOPs) or single-thread latency of the computation job part ji. Finally, assuming C computing cores available, each task may be allocated a number of computing nodes relative to its weight, namely, we assign ci=max {1, floor[wi*C]} cores for the part ji. This effectively means allocating ci worker threads for ji.

Note that the sum of all allocated processing cores may be larger than the available cores C. This should be clear as the number of tasks itself may be larger than C, but it is possible even when k≤C. This suggests, merely, that some job parts will be run after other job parts have finished (rather than running them all in parallel). At the same time, due to a rounding-down (floor) function intended to reduce the above possibility of over-subscription, some unallocated cores might remain. To avoid this waste of available resources, tasks may be sorted by their remaining unallocated weight, e.g., by wi*C—floor[wi*C], and assign one core to each task in the descending order until all cores are allocated.

The C++-like pseudo-code for entire algorithm is given as:

| | |
|---|---|
| 1 | vector<int> allocate(vector<Tensor> inputs, int numCores) { |
| 2 | vector<int> threadAllocation; |
| 3 | vector<tuple<int, float>> threadUnallocatedWeight; |
| 4 | int numInputs = inputs.size( ); |
| 5 | int allocatedCores = 0; |
| 6 | int index = 0; |
| 7 | int totalSize = 0; |
| 8 | for (auto j_i : inputs) totalSize += j_i.size( ) |
| 9 | for (auto j_i : inputs) { |
| 10 | int numThreadsToUse = 1; |
| 11 | if (numInputs <= numCores) { |
| 12 | int size = j_i.size( ); |
| 13 | float w_i = ((float)size) / totalSize; |
| 14 | |
| 15 | // this may happen due to flooring |
| 16 | if (numThreadsToUse < 1) numThreadsToUse = 1; |
| 17 | |
| 18 | unallocatedWeight.add(make_tuple(index, w_i * numCores − |

numThreadsToUse));

| | |
|---|---|
| 19 | } |
| 20 | threadAllocation.add(numThreadsToUse); |
| 21 | allocatedCores += numThreadsToUse; |
| 22 | index++; |
| 23 | } |
| 24 | if (allocatedCores < numCores) { |
| 25 | // sort the vector in decreasing order by |
| 26 | // comparing the second field in each tuple |
| 27 | sort(unallocatedWeight, bySecondField); |
| 28 | int nextToAdjust = 0; |
| 29 | while (allocatedCores < numCores) { |
| 30 | // fetch the first field in the ‘nextToAdjust’ tuple |
| 31 | index = |
| 32 | unallocatedWeight[nextToAdjust % numInputs].get(0); |
| 33 | threadAllocation[index]++; |
| 34 | allocatedCores++; |
| 35 | nextToAdjust++; |
| 36 | } |
| 37 | } |
| 38 | return threadAllocation; |
| 39 | } |

Assigning relative weight to a job part may, in some embodiments, be accomplished with the help of a profiling phase and a lightweight classification mechanism which associates job parts of the same (or similar) shape (as the one encountered during the profiling phase) to the relative weight obtained during profiling. However, in some embodiments, the weight may simply be set proportional to the expected size of input data. Specifically, let si be the size of an input tensor for job part ji. We set wi to si divided by the sum of the sizes of input tensors of all job parts. In various embodiments, such a weighting factor may be effective when the amount of computation (expressed as the number of required FLOPs) grows roughly linearly with input tensor size.

Allocation of resources may iterate over the list of inputs, calculating their sizes and corresponding relative weights, and then apply the above allocation pseudo-code to associate the number of worker threads with each input (job part). Following that, in some embodiments one worker thread may be created for each input and the worker threads run in parallel. Each worker thread, in turn, creates a thread pool of the size calculated by the above pseudo-code (the thread pool includes the worker thread itself), and executes the task on that input.

In some embodiments, application code may be changed to use a modified API. Instead of invoking run for every job, the application needs to create a list of job parts and call a parallel run (prun) function. In addition, the application may then rearrange post-processing code to iterate over the results of prun, and apply any post-processing to each returned output (object). As an example of what the user code changes may entail, the following is original Python code (edited for brevity and clarity) of the TextRecognizer class in PaddleOCR:

| | |
|---|---|
| 1 | class TextRecognizer(object): |
| 2 | def_init_(self, args): |
| 3 | ... |
| 4. | self.predictor = ort.InferenceSession(args.file_path) |
| 5 | self.postprocess_op = build_post_process(args) |
| 6 | ... |
| 7 | def_call_(self, img_list): |
| 8 | img_num = len(img_list) |
| 9 | for beg_img_no in range(0, img_num, batch_num): |
| 10 | end_img_no = min(img_num, beg_img_no + batch_num) |
| 11 | inputs = prepare(img_list, beg_img_no, end_img_no) |
| 12 | outputs = self.predictor.run(inputs) |
| 13 | preds = outputs[0] |
| 14 | rec_result = self.postprocess_op(preds) |
| 15 | all_results.add(rec_result) |
| 16 | return all_results |

The following is a modified version of the Python code above that makes use of the new prun API:

| | |
|---|---|
| 1 | class TextRecognizer(object): |
| 2 | def_init_(self, args): |
| 3 | ... |
| 4 | self.predictor = ort.InferenceSession(args.file_path) |
| 5 | self.postprocess_op = build_post_process(args) |
| 6 | ... |
| 7 | def_call_(self, img_list): |
| 8 | img_num = len(img_list) |
| 9 | for beg_img_no in range(0, img_num, batch_num): |
| 10 | end_img_no = min(img_num, beg_img_no + batch_num) |
| 11 | inputs = prepare(img_list, beg_img_no, end_img_no) |
| 12 | all_inputs.append(inputs) |
| 13 | all_outputs = self.predictor.prun(all_inputs) |
| 14 | for outputs in all_outputs: |
| 15 | preds = outputs[0] |
| 16 | rec_result = self.postprocess_op(preds) |
| 17 | all_results.add(rec_result) |
| 18 | return all_results |

It should be understood that various embodiments of a divide-and-conquer approach to scalability in ML inference may not directly address reasons for poor scalability detailed above. In fact, the advantage of such an approach is that one does not have to identify and/or fix any scalability bottlenecks to achieve benefits of the underlying idea.

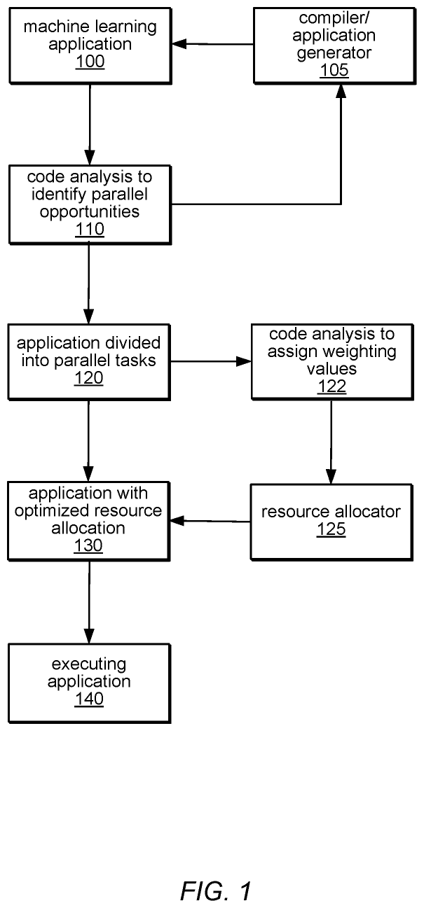

FIG. 1 is a block diagram illustrating preparation of a machine learning application for execution using a divide-and-conquer technique, in various embodiments. An application 100, such as application providing inferences using a trained machine learning model, may be prepared for execution using a divide-and-conquer technique. Although an inference stage of a machine learning system will be used as an exemplary application below, it should be understood that the technique could apply to any number of applications and machine learning applications are not intended to be limiting.

The application 100 may be submitted for code analysis to identify opportunities to divide the application into independently executable tasks or chunks. In various embodiments, this code analysis may be performed at a source code level or executable code level. Results of the analysis may be provided to an application generator 105, such as a compiler or source code management system, either manually or automatically, to generate modifications to the application 100 to enable division of the application into tasks according to the code analysis 110.

As a result of code analysis 110, a modified application 120 may be generated that is divided into parallel tasks for execution, in various embodiments. These various parallel tasks may then be analyzed 122 to assign weighting values proportional to expected execution demand. The results of this analysis may be provided to a resource allocator that assigns finite resources, including processor cores, to the various tasks according to their respective weighting values and overall resource demand for the application.

Assigning relative weighting factors to the various tasks may, in some embodiments, be accomplished with the help of a profiling phase and a lightweight classification mechanism which associates job parts of the same (or similar) shape (as the one encountered during the profiling phase) to the relative weight obtained during profiling. In some embodiments, the weight may simply set proportional to the expected size of input data. Specifically, let si be the size of an input tensor for job part ji. We set wi to si divided by the sum of the sizes of input tensors of all job parts. In various embodiments, such a weighting factor may be effective when the amount of computation (expressed as the number of required FLOPs) grows roughly linearly with input tensor size.

As a result of code analysis 122, the modified application may have computing resources allocated proportional to expected execution demand, in various embodiments. The application may then be executed 140 according to the allocated computing resources.

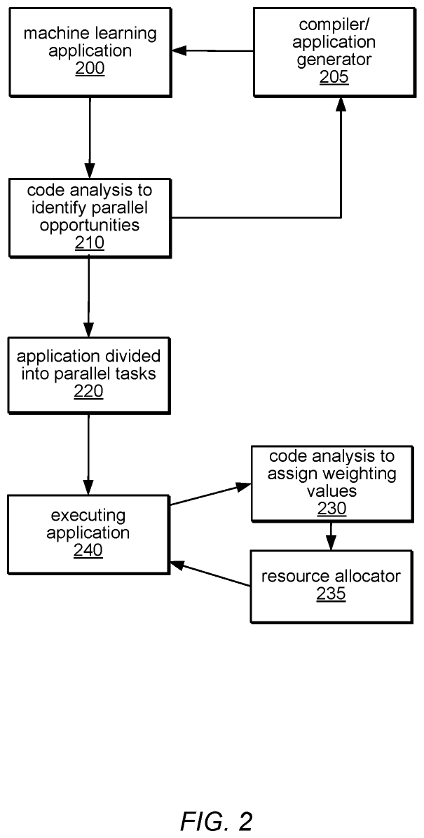

FIG. 2 is a block diagram illustrating an optical character recognition system accelerated using a divide-and-conquer technique and dynamic resource allocation, in various embodiments. An application 200, such as application providing inferences using a trained machine learning model, may be prepared for execution using a divide-and-conquer technique.

The application 200 may be submitted for code analysis to identify opportunities to divide the application into independently executable tasks or chunks. In various embodiments, this code analysis may be performed at a source code level or executable code level. Results of the analysis may be provided to an application generator 205, such as a compiler or source code management system, either manually or automatically, to generate modifications to the application 200 to enable division of the application into tasks according to the code analysis 210.

As a result of code analysis 210, a modified application 220 may be generated that is divided into parallel tasks for execution, in various embodiments. The application may then be executed 240 according to the allocated computing resources. During execution, the various executing parallel tasks may then be analyzed 230 to assign weighting values proportional to measure or expected execution demand. The results of this analysis may be provided to a resource allocator that assigns finite resources, including processor cores, to the various tasks according to their respective weighting values and overall resource demand for the application.

### Exemplary Optical Character Recognition Application

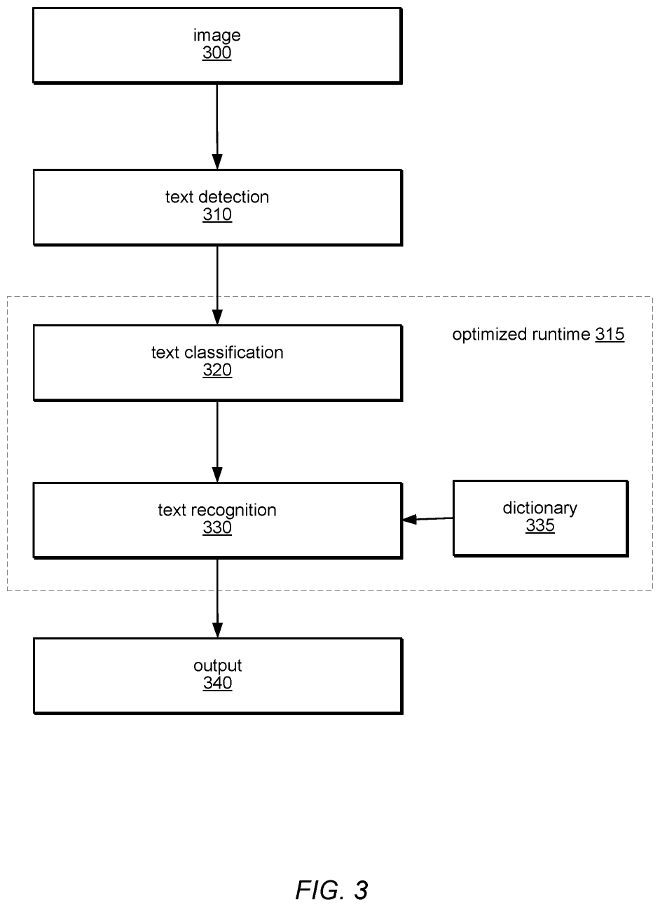

FIG. 3 is a block diagram illustrating an optical character recognition system accelerated using a divide-and-conquer technique, in various embodiments. In some embodiments, the divide-and-conquer technique may be applied to a lightweight optical character recognition (OCR) application. Such an OCR system may consist of three parts: Text Detection 310, Text Classification 320 and Text Recognition 330. Each of those parts may correspond to a separate ML model, in some embodiments.

An OCR pipeline may accept an image file 300 and pass it first through a text detection phase 310 to locate text areas in the image. The output of this phase may be a list of potential text box coordinates, in some embodiments. Next, the list of potential text box coordinates may be iterated over and each item in that list (e.g., a text box) sent to the text classification model 320. In some embodiments, this text classification model may decide whether the box needs to be transformed into a horizontal rectangle box before the actual text recognition takes place.

Based on a classifier 320 decision, each box may be respectively altered. Finally, the list may be iterated over again, with each item sent to the text recognition model 330 for inference, in some embodiments. The text recognition model 330 may recognize the text in the given box and produce the actual character sequence based on a supplied character dictionary 335. The actual character sequence may then be output 340.

In some embodiments, a divide-and-conquer technique may be applied to the last two phases of the OCR pipeline, namely the Text Classification and Recognition. To that end, rather that invoking the corresponding models for each text box produced by Text Detection 310, all the boxes may be sent to an optimized runtime 315 (by invoking the prun API) and effectively let the runtime decide how many cores/worker threads to allocate each box based on its relative size.

In some embodiments, performance improvement may be proportional to a number of detected text boxes. For a cases where a number of detected boxes is low, performance may be at parity or modestly improved, while with a greater number of detected boxes overall latency may be substantially reduced. Quantitively, the text recognition phase may, in some embodiments, be far more dominant than the text classification phase. In some embodiments, a dynamic mechanism which would choose the best thread allocation strategy based on the given workload and available resources may be preferred.

### Exemplary Natural Language Processing Application

A natural language processing (NLP) system may be accelerated using a divide-and-conquer technique, in various embodiments. In some embodiments, an NLP architecture may consist of a stack of layers, each composed of a self-attention block followed by a fully connected network. Empirically, the majority of computation cycles may be spent on (scalable) matrix multiplication operations, yet up to one third of computing time may be spent elsewhere.

One way to improve the inference performance of an NLP system is through input batching. This strategy works well when the inputs have the same length. Otherwise, batching requires padding inputs to the same length resulting in wasted computation cycles. This presents an ideal case for applying the Divide-and-Conquer Principle. Instead of padding the inputs of various lengths up to the longest input in the batch, inference may be run on those inputs as they are, without padding, using the prun API, while allowing the runtime to decide how many cores should be used to process each of the inputs. Thus, using Divide-and-Conquer Principle, batches of a given size may be modified to use a smaller batch size, or a batch size of a single element, with individual batches including an element size requiring reduced or eliminated padding size, in various embodiments.

While a larger batch of (padded) sequences helps to achieve better throughput in conventional NLP processing, dramatic throughput growth can be achieved when adding short sequences in a batch. While NLP systems may employ scalable matrix multiplication operations, they also employ less scalable operations. The impact of the latter grows with the increase in the number of cores. Therefore, one may benefit from the Divide-and-Conquer Principle applied to NLP even when the batch includes inputs of the same length.

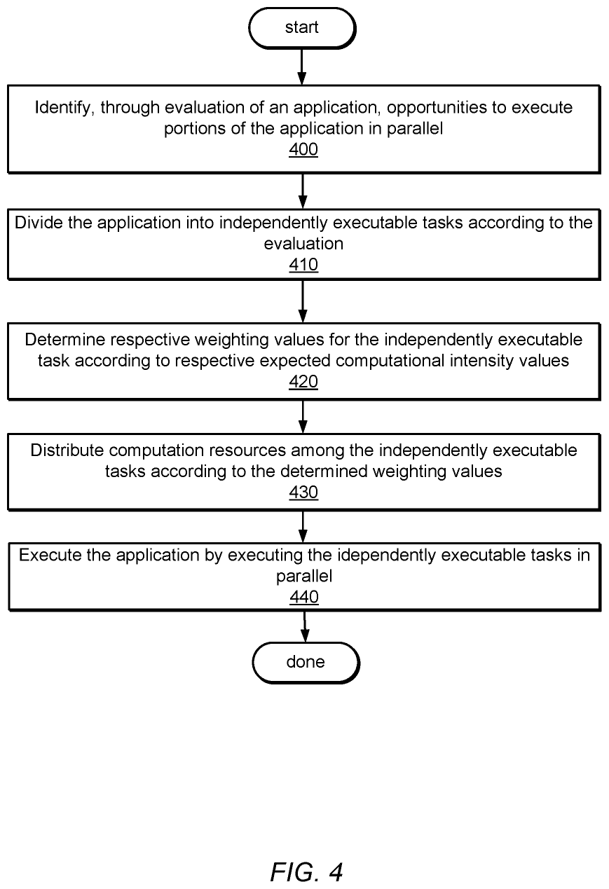

FIG. 4 is a flow diagram illustrating preparation of an application for execution using a divide-and-conquer technique, in various embodiments. An application, such as the application 100 of FIG. 1, may be prepared for execution using a divide-and-conquer technique. As shown in 400, the application may be evaluated to identify opportunities to execute portions of the application in parallel. In some embodiments, this code evaluation may be performed at a source code level or executable code level and may be done manually or with the assistance of code evaluation tools. Such evaluation may employ code profiling techniques or the use of analysis of library or API calls. These examples of code evaluation are not intended to be limiting and any number of analysis techniques may be employed.

As shown in 410, the application may then be divided into independently executable tasks or code blocks, in some embodiments. This partitioning of the application may be performed in various ways, in some embodiments. For example, in some embodiments, the partitioning may be performed using a configuration tool. In other embodiments, partitioning may be performed through direct modification of the code of the application, such as the modification of interpreted code or scripting code. In still other embodiments, partitioning may be performed through modification of application source code with the application redeployed through use of application development tools such as compilers. These examples are not intended to be limiting and any number of means of partitioning the application may be envisioned.

The partitioning of the application may result in a modified application such as the divided application 120 as shown in FIG. 1, in some embodiments. As shown in 420, the independently executable tasks may then be analyzed to assign respective weighting values proportional to expected execution demand. The results of this analysis may be provided to a resource allocator, such as the resource allocator 125 of FIG. 1, that assigns finite resources, including processor cores, to the various tasks according to their respective weighting values and overall resource demand for the application.

Assigning relative weighting factors to the various tasks may, in some embodiments, be accomplished with the help of a profiling phase and a lightweight classification mechanism which associates job parts of the same (or similar) shape (as the one encountered during the profiling phase) to the relative weight obtained during profiling. In some embodiments, the respective weighting values may be set proportional to respective expected sizes of input data. In various embodiments, such a weighting factor may be effective when the amount of computation (expressed as the number of required FLOPs) grows roughly linearly with input tensor size. It should be understood that these are merely examples of determining expected execution demand and that any number of techniques to determine expected execution demand may be imagined. Furthermore, expected execution demand may be further determined, or entirely determined, during execution of the application to dynamically adjust the parallel execution of the application.

As shown in 430, computational resources, such as processor cores and executable threads, may be distributed among the independently executable tasks according to the determined weighting values. Such distribution, in some embodiments, may be performed by a resource allocator such as the resource allocator 125 of FIG. 1. In some embodiments resource allocation may be performed using a configuration tool. In other embodiments, resource allocation may be performed through direct modification of the code of the application, such as the modification of interpreted code or scripting code. In still other embodiments, partitioning may be performed through modification of application source code with the application redeployed through use of application development tools such as compilers. Furthermore, resource allocation may be performed through the use of data tables which may be either statically or dynamically determined. These examples are not intended to be limiting and any number of means of partitioning the application may be envisioned.

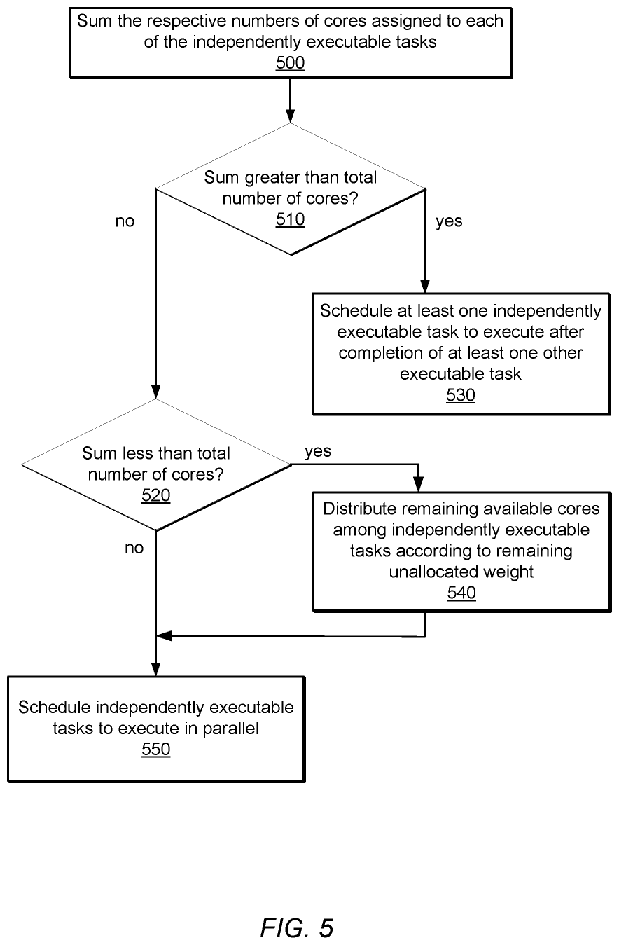

For example, processing or computational cores may be assigned to the individual ones of independently executable tasks according to a product of their respective weighting values and a total number of computational cores. Assuming C computing cores as available, each task may be allocated a number of computing cores relative to its weight, namely, we assign ci=max {1, floor[wi*C]} cores for the part ji. This effectively means allocating ci worker threads for ji. It should be noted that a total number of allocated computing cores may, or may not, exceed the available number of computing cores, C. In some embodiments, this may be handled using a process described below in FIG. 5.

As a result of resource allocation, the application may then be executed using the divide-and-conquer technique by executing individual ones of the independently executable tasks in parallel, as shown in 440. It should be noted that execution of the tasks may be initiated either before or after performance of steps 420 and 430, thereby implementing the techniques described above in FIGS. 1 and 2, respectively. Furthermore, step 420 may be performed both statically prior to execution of the application and subsequent to initiation of execution of the application, thus incorporating features disclosed in both FIG. 1 and FIG. 2.

FIG. 5 is a flow diagram illustrating scheduling of a divided application for execution according to assigned core counts, in various embodiments. In some embodiments, an application may be divided into independently executable tasks and computational cores assigned to individual ones of the tasks according to determined weighting factors of the tasks, as discussed in in FIGS. 1, 2 and 4. A total number of cores assigned to execute the task may exceed a total number of available cores, in some embodiments. In this case, execution may be scheduled such that the total number of cores used is less than the total number of available core.

As shown in 500, the respective numbers of assigned cores for each of the individually executable tasks may be summed to determine a maximum number of cores needed to execute the application entirely in parallel. This maximum number of cores may then be compared to the available number of cores to determine a scheduling strategy, in some embodiments.

If the total number of available cores meets or exceeds the maximum number of cores needed to execute the application entirely in parallel, as indicated in a negative exit from 510, the process may continue to step 520, where it may be determined if additional cores in excess of allocated cores exist. If additional cores are available, as indicated in a positive exit from 520, the process may advance to 540. If no additional cores are available, as indicated in a negative exit from 520, the process may advance to 550, in some embodiments.

As shown in 540, remaining cores available for allocation may be assigned among the independently executable tasks, in some embodiments. To avoid wasting available resources, independently executable tasks may be sorted by remaining unallocated weight, e.g., by wi*C—floor[wi*C], and one of the remaining cores assigned to each task in the descending order until all cores are allocated, in some embodiments. The process may then advance to 550.

As shown in 550, all independently executable tasks may then be scheduled for execution in parallel, in some embodiments.

If the total number of available cores does not exceed the maximum number of cores needed to execute the application entirely in parallel, as indicated in a positive exit from 510, the process may continue to step 530, where a portion of the independently executable tasks may be scheduled for initial execution in parallel, while one or more independently executable tasks may be scheduled to wait for completion of another at least one independently executable task such that a number of scheduled cores does not exceed the total number of available cores, in some embodiments.

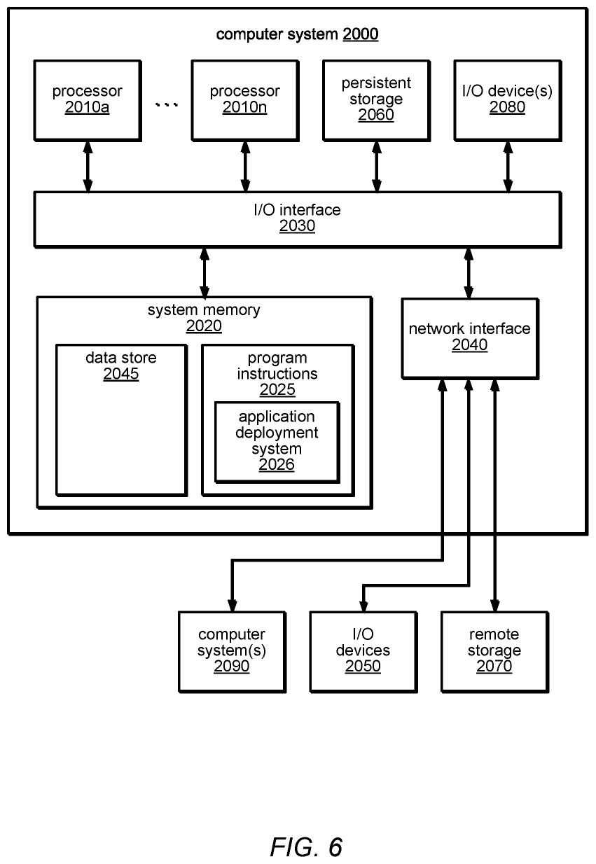

Any of various computer systems may be configured to implement processes associated with a technique for multi-region, multi-primary data store replication as discussed with regard to the various figures above. FIG. 6 is a block diagram illustrating one embodiment of a computer system suitable for implementing some or all of the techniques and systems described herein. In some cases, a host computer system may host multiple virtual instances that implement the servers, request routers, storage services, control systems or client(s). However, the techniques described herein may be executed in any suitable computer environment (e.g., a cloud computing environment, as a network-based service, in an enterprise environment, etc.).

Various ones of the illustrated embodiments may include one or more computer systems 2000 such as that illustrated in FIG. 6 or one or more components of the computer system 2000 that function in a same or similar way as described for the computer system 2000.

In the illustrated embodiment, computer system 2000 includes one or more processors 2010 coupled to a system memory 2020 via an input/output (I/O) interface 2030. Computer system 2000 further includes a network interface 2040 coupled to I/O interface 2030. In some embodiments, computer system 2000 may be illustrative of servers implementing enterprise logic or downloadable applications, while in other embodiments servers may include more, fewer, or different elements than computer system 2000.

Computer system 2000 includes one or more processors 2010 (any of which may include multiple cores, which may be single or multi-threaded) coupled to a system memory 2020 via an input/output (I/O) interface 2030. Computer system 2000 further includes a network interface 2040 coupled to I/O interface 2030. In various embodiments, computer system 2000 may be a uniprocessor system including one processor 2010, or a multiprocessor system including several processors 2010 (e.g., two, four, eight, or another suitable number). Processors 2010 may be any suitable processors capable of executing instructions. For example, in various embodiments, processors 2010 may be general-purpose or embedded processors implementing any of a variety of instruction set architectures (ISAs), such as the x86, PowerPC, SPARC, or MIPS ISAs, or any other suitable ISA. In multiprocessor systems, each of processors 2010 may commonly, but not necessarily, implement the same ISA. The computer system 2000 also includes one or more network communication devices (e.g., network interface 2040) for communicating with other systems and/or components over a communications network (e.g. Internet, LAN, etc.). For example, a client application executing on system 2000 may use network interface 2040 to communicate with a server application executing on a single server or on a cluster of servers that implement one or more of the components of the embodiments described herein. In another example, an instance of a server application executing on computer system 2000 may use network interface 2040 to communicate with other instances of the server application (or another server application) that may be implemented on other computer systems (e.g., computer systems 2090).

System memory 2020 may store instructions and data accessible by processor 2010. In various embodiments, system memory 2020 may be implemented using any suitable memory technology, such as static random-access memory (SRAM), synchronous dynamic RAM (SDRAM), non-volatile/Flash-type memory, or any other type of memory. In the illustrated embodiment, program instructions and data implementing desired functions, such as those methods and techniques as described above for an application deployment system as indicated at 2026, for the downloadable software or provider network are shown stored within system memory 2020 as program instructions 2025. In some embodiments, system memory 2020 may include data store 2045 which may be configured as described herein.

In some embodiments, system memory 2020 may be one embodiment of a computer-accessible medium that stores program instructions and data as described above. However, in other embodiments, program instructions and/or data may be received, sent or stored upon different types of computer-accessible media. Generally speaking, a computer-accessible medium may include computer-readable storage media or memory media such as magnetic or optical media, e.g., disk or DVD/CD-ROM coupled to computer system 2000 via I/O interface 2030. A computer-readable storage medium may also include any volatile or non-volatile media such as RAM (e.g. SDRAM, DDR SDRAM, RDRAM, SRAM, etc.), ROM, etc., that may be included in some embodiments of computer system 2000 as system memory 2020 or another type of memory. Further, a computer-accessible medium may include transmission media or signals such as electrical, electromagnetic, or digital signals, conveyed via a communication medium such as a network and/or a wireless link, such as may be implemented via network interface 2040.

In one embodiment, I/O interface 2030 may coordinate I/O traffic between processor 2010, system memory 2020 and any peripheral devices in the system, including through network interface 2040 or other peripheral interfaces. In some embodiments, I/O interface 2030 may perform any necessary protocol, timing or other data transformations to convert data signals from one component (e.g., system memory 2020) into a format suitable for use by another component (e.g., processor 2010). In some embodiments, I/O interface 2030 may include support for devices attached through various types of peripheral buses, such as a variant of the Peripheral Component Interconnect (PCI) bus standard or the Universal Serial Bus (USB) standard, for example. In some embodiments, the function of I/O interface 2030 may be split into two or more separate components, such as a north bridge and a south bridge, for example. Also, in some embodiments, some or all of the functionality of I/O interface 2030, such as an interface to system memory 2020, may be incorporated directly into processor 2010.

Network interface 2040 may allow data to be exchanged between computer system 2000 and other devices attached to a network, such as between a client device and other computer systems, or among hosts, for example. In particular, network interface 2040 may allow communication between computer system 800 and/or various other device 2060 (e.g., I/O devices). Other devices 2060 may include scanning devices, display devices, input devices and/or other communication devices, as described herein. Network interface 2040 may commonly support one or more wireless networking protocols (e.g., Wi-Fi/IEEE 802.7, or another wireless networking standard). However, in various embodiments, network interface 2040 may support communication via any suitable wired or wireless general data networks, such as other types of Ethernet networks, for example. Additionally, network interface 2040 may support communication via telecommunications/telephony networks such as analog voice networks or digital fiber communications networks, via storage area networks such as Fibre Channel SANs, or via any other suitable type of network and/or protocol.

In some embodiments, I/O devices may be relatively simple or “thin” client devices. For example, I/O devices may be implemented as dumb terminals with display, data entry and communications capabilities, but otherwise little computational functionality. However, in some embodiments, I/O devices may be computer systems implemented similarly to computer system 2000, including one or more processors 2010 and various other devices (though in some embodiments, a computer system 2000 implementing an I/O device 2050 may have somewhat different devices, or different classes of devices).

In various embodiments, I/O devices (e.g., scanners or display devices and other communication devices) may include, but are not limited to, one or more of: handheld devices, devices worn by or attached to a person, and devices integrated into or mounted on any mobile or fixed equipment, according to various embodiments. I/O devices may further include, but are not limited to, one or more of: personal computer systems, desktop computers, rack-mounted computers, laptop or notebook computers, workstations, network computers, “dumb” terminals (e.g., computer terminals with little or no integrated processing ability), Personal Digital Assistants (PDAs), mobile phones, or other handheld devices, proprietary devices, printers, or any other devices suitable to communicate with the computer system 2000. In general, an I/O device (e.g., cursor control device, keyboard, or display(s) may be any device that can communicate with elements of computing system 2000.

The various methods as illustrated in the figures and described herein represent illustrative embodiments of methods. The methods may be implemented manually, in software, in hardware, or in a combination thereof. The order of any method may be changed, and various elements may be added, reordered, combined, omitted, modified, etc. For example, in one embodiment, the methods may be implemented by a computer system that includes a processor executing program instructions stored on a computer-readable storage medium coupled to the processor. The program instructions may be configured to implement the functionality described herein.

Various modifications and changes may be made as would be obvious to a person skilled in the art having the benefit of this disclosure. It is intended to embrace all such modifications and changes and, accordingly, the above description to be regarded in an illustrative rather than a restrictive sense.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

Embodiments of decentralized application development and deployment as described herein may be executed on one or more computer systems, which may interact with various other devices. FIG. 6 is a block diagram illustrating an example computer system, according to various embodiments. For example, computer system 2000 may be configured to implement nodes of a compute cluster, a distributed key value data store, and/or a client, in different embodiments. Computer system 2000 may be any of various types of devices, including, but not limited to, a personal computer system, desktop computer, laptop or notebook computer, mainframe computer system, handheld computer, workstation, network computer, a consumer device, application server, storage device, telephone, mobile telephone, or in general any type of compute node, computing node, or computing device.

In the illustrated embodiment, computer system 2000 also includes one or more persistent storage devices 2060 and/or one or more I/O devices 2080. In various embodiments, persistent storage devices 2060 may correspond to disk drives, tape drives, solid state memory, other mass storage devices, or any other persistent storage device. Computer system 2000 (or a distributed application or operating system operating thereon) may store instructions and/or data in persistent storage devices 2060, as desired, and may retrieve the stored instruction and/or data as needed. For example, in some embodiments, computer system 2000 may be a storage host, and persistent storage 2060 may include the SSDs attached to that server node.

In some embodiments, program instructions 2025 may include instructions executable to implement an operating system (not shown), which may be any of various operating systems, such as UNIX, LINUX, Solaris™, MacOS™, Windows™, etc. Any or all of program instructions 2025 may be provided as a computer program product, or software, that may include a non-transitory computer-readable storage medium having stored thereon instructions, which may be used to program a computer system (or other electronic devices) to perform a process according to various embodiments. A non-transitory computer-readable storage medium may include any mechanism for storing information in a form (e.g., software, processing application) readable by a machine (e.g., a computer). Generally speaking, a non-transitory computer-accessible medium may include computer-readable storage media or memory media such as magnetic or optical media, e.g., disk or DVD/CD-ROM coupled to computer system 2000 via I/O interface 2030. A non-transitory computer-readable storage medium may also include any volatile or non-volatile media such as RAM (e.g. SDRAM, DDR SDRAM, RDRAM, SRAM, etc.), ROM, etc., that may be included in some embodiments of computer system 2000 as system memory 2020 or another type of memory. In other embodiments, program instructions may be communicated using optical, acoustical or other form of propagated signal (e.g., carrier waves, infrared signals, digital signals, etc.) conveyed via a communication medium such as a network and/or a wireless link, such as may be implemented via network interface 2040.

It is noted that any of the distributed system embodiments described herein, or any of their components, may be implemented as one or more network-based services. For example, a compute cluster within a computing service may present computing services and/or other types of services that employ the distributed computing systems described herein to clients as network-based services. In some embodiments, a network-based service may be implemented by a software and/or hardware system designed to support interoperable machine-to-machine interaction over a network. A network-based service may have an interface described in a machine-processable format, such as the Web Services Description Language (WSDL). Other systems may interact with the network-based service in a manner prescribed by the description of the network-based service's interface. For example, the network-based service may define various operations that other systems may invoke and may define a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol such as Simple Object Access Protocol (SOAP). To perform a network-based services request, a network-based services client may assemble a message including the request and convey the message to an addressable endpoint (e.g., a Uniform Resource Locator (URL)) corresponding to the network-based service, using an Internet-based application layer transfer protocol such as Hypertext Transfer Protocol (HTTP).

In some embodiments, network-based services may be implemented using Representational State Transfer (“RESTful”) techniques rather than message-based techniques. For example, a network-based service implemented according to a RESTful technique may be invoked through parameters included within an HTTP method such as PUT, GET, or DELETE, rather than encapsulated within a SOAP message.

Although the embodiments above have been described in considerable detail, numerous variations and modifications may be made as would become apparent to those skilled in the art once the above disclosure is fully appreciated. It is intended that the following claims be interpreted to embrace all such modifications and changes and, accordingly, the above description to be regarded in an illustrative rather than a restrictive sense.

What is claimed is:

1. A method, comprising:
evaluating an application to identify a plurality of opportunities to execute the application in parallel;
dividing the application according to the identified plurality of opportunities into a plurality of independently executable tasks;
determining respective weighting values for individual ones of the plurality of independently executable tasks according to respective expected computational intensity values of the individual ones of the plurality of independently executable tasks;
distributing a plurality of computational resources among the individual ones of the plurality of independently executable tasks according to the respective weighting values; and
executing the divided application using the distributed plurality of computational resources.

2. The method of claim 1, wherein the application comprises a multi-phase pipeline, and wherein individual ones of the plurality of independently executable tasks correspond to respective phases of the multi-phase pipeline.

3. The method of claim 2, wherein a particular phase of the multi-phase pipeline is a batch processing phase, wherein the batch processing phase processes data in batches of a first size, and wherein an independently executable task corresponding to the batch processing phase processes data in batches of a second size less than the first size.

4. The method of claim 2, wherein a particular phase of the multi-phase pipeline is a batch processing phase processing individual elements of the data padded to a first element size, and wherein an independently executable task corresponding to the batch processing phase processes the individual elements of data padded to at least a second element size different from the first element size.

5. The method of claim 1, wherein distributing the plurality of computational resources among the individual ones of the plurality of independently executable tasks according to the respective weighting values comprises:
assigning respective numbers of computational cores to the individual ones of the plurality of independently executable tasks according to a product of respective weighting values of the individual ones of the plurality of independently executable tasks and a total number of computational cores.

6. The method of claim 5, wherein executing the divided application using the distributed plurality of computational resources comprises:
summing the respective numbers of computational cores to calculate a total number of assigned computational cores;
scheduling the individual ones of the plurality of independently executable tasks to execute in parallel responsive to determining that the total number of assigned computational cores is not greater than the total number of computational cores; and
scheduling a portion of the plurality of independently executable tasks to execute after completion of at least one of the plurality of independently executable tasks responsive to determining that the total number of assigned computational cores is greater than the total number of computational cores.

7. The method of claim 1, wherein the application is a machine learning application.

8. One or more non-transitory computer-accessible storage media storing program instructions that when executed on or across one or more computing devices cause the one or more computing devices to implement:
evaluating an application to identify a plurality of opportunities to execute the application in parallel;
dividing the application according to the identified plurality of opportunities into a plurality of independently executable tasks;
determining respective weighting values for individual ones of the plurality of independently executable tasks according to respective expected computational intensity values of the individual ones of the plurality of independently executable tasks; and
distributing a plurality of computational resources among the individual ones of the plurality of independently executable tasks according to the respective weighting values.

9. The one or more non-transitory computer-accessible storage media of claim 8, wherein the application comprises a multi-phase pipeline, and wherein individual ones of the plurality of independently executable tasks correspond to respective phases of the multi-phase pipeline.

10. The one or more non-transitory computer-accessible storage media of claim 9, wherein a particular phase of the multi-phase pipeline is a batch processing phase, wherein the batch processing phase processes data in batches of a first size, and wherein an independently executable task corresponding to the batch processing phase processes data in batches of a second size less than the first size.

11. The one or more non-transitory computer-accessible storage media of claim 9, wherein a particular phase of the multi-phase pipeline is a batch processing phase processing individual elements of the data padded to a first element size, and wherein an independently executable task corresponding to the batch processing phase processes the individual elements of data padded to at least a second element size different from the first element size.

12. The one or more non-transitory computer-accessible storage media of claim 8, wherein distributing the plurality of computational resources among the individual ones of the plurality of independently executable tasks according to the respective weighting values comprises:
assigning respective numbers of computational cores to the individual ones of the plurality of independently executable tasks according to a product of respective weighting values of the individual ones of the plurality of independently executable tasks and a total number of computational cores.

13. The one or more non-transitory computer-accessible storage media of claim 12, further comprising scheduling execution of the application using the distributed plurality of computational resources, comprising:
summing the respective numbers of computational cores to calculate a total number of assigned computational cores;
scheduling the individual ones of the plurality of independently executable tasks to execute in parallel responsive to determining that the total number of assigned computational cores is not greater than the total number of computational cores; and
scheduling a portion of the plurality of independently executable tasks to execute after completion of at least one of the plurality of independently executable tasks responsive to determining that the total number of assigned computational cores is greater than the total number of computational cores.

14. The one or more non-transitory computer-accessible storage media of claim 8, wherein the application is a natural language processing application.

15. A system, comprising:
one or more processors; and
a memory storing program instructions that when executed by the one or more processors cause the one or more processors to implement an application deployment platform, configured to:
evaluate an application to identify a plurality of opportunities to execute the application in parallel;
divide the application according to the identified plurality of opportunities into a plurality of independently executable tasks;
determine respective weighting values for individual ones of the plurality of independently executable tasks according to respective expected computational intensity values of the individual ones of the plurality of independently executable tasks; and
distribute a plurality of computational resources among the individual ones of the plurality of independently executable tasks according to the respective weighting values.

16. The system of claim 15, wherein the application comprises a multi-phase pipeline, and wherein individual ones of the plurality of independently executable tasks correspond to respective phases of the multi-phase pipeline.

17. The system of claim 16, wherein a particular phase of the multi-phase pipeline is a batch processing phase, wherein the batch processing phase processes data in batches of a first size, and wherein an independently executable task corresponding to the batch processing phase processes data in batches of a second size less than the first size.

18. The system of claim 16, wherein a particular phase of the multi-phase pipeline is a batch processing phase processing individual elements of the data padded to a first element size, and wherein an independently executable task corresponding to the batch processing phase processes the individual elements of data padded to at least a second element size different from the first element size.

19. The system of claim 15, wherein to distribute the plurality of computational resources among the individual ones of the plurality of independently executable tasks according to the respective weighting values, the application deployment platform is configured to:
assign respective numbers of computational cores to the individual ones of the plurality of independently executable tasks according to a product of respective weighting values of the individual ones of the plurality of independently executable tasks and a total number of computational cores.

20. The system of claim 15, wherein the application deployment platform is further configured to:
sum the respective numbers of computational cores to calculate a total number of assigned computational cores;
schedule the individual ones of the plurality of independently executable tasks to execute in parallel responsive to determining that the total number of assigned computational cores is not greater than the total number of computational cores; and
schedule a portion of the plurality of independently executable tasks to execute after completion of at least one of the plurality of independently executable tasks responsive to determining that the total number of assigned computational cores is greater than the total number of computational cores.
